(19) United States
(12) Patent Application Publication
(10) Pub. No.: US 2015/0310181 A1
(43) Pub. Date: Oct. 29, 2015

(54) Portable System and Method for Guiding Treatment of Patients

(71) Applicant: Eventium, Milwaukee, WI (US)

(72) Inventor: Janelle Schroeder, Wauwatosa, WI (US)

(73) Assignee: Eventium, Milwaukee, WI (US)

(21) Appl. No.: 14/263,671

(22) Filed: Apr. 28, 2014

(51) Int. Cl. G06F 19/00; G06Q 50/22

(52) U.S. Cl. CPC G06F 19/3418; G06Q 50/22

(57) ABSTRACT

The inventors have recognized that precise synchronization of remote data coupled with local compression and verification technologies enables healthcare providers to employ a device with locally stored patient information and clinical pathways for providing improved healthcare services in dynamic and remote environments. Patient information may be mapped to code sets and reported to patients and/or exchanged with health care organizations accordingly. In addition, patient information may be aggregated with other patient information to provide further improved localized results. Accordingly, more efficient, consistent and reliable healthcare services may be provided to patients in dynamic and remote environments.

### BACKGROUND OF THE INVENTION

The present invention is directed to the field of health care, and more particularly, to a system and method for guiding the treatment of patients.

Health care providers are increasingly called upon to provide healthcare services for patients in dynamic and remote environments. For example, healthcare providers are often asked to provide care in home settings, hospices, transitional care centers, non-traditional healthcare settings and rural locations. In addition, particular patient's locations may vary from time to time, and a healthcare provider's list of patients may be geographically dispersed. Accordingly, healthcare providers must bring with them the knowledge and tools necessary to effectively provide such services to patients in their respective locations.

Healthcare providers have known to use certain “outcome based” approaches in providing healthcare services for patients. Such approaches may vary among healthcare providers, but often include determining a patient's plan of care, assessing the patient during a visit, and taking subsequent actions based on the plan of care and the assessment. In the past, these approaches have been carried out using volumes of printed materials, including binders, checklists and worksheets. However, handling such printed materials is often cumbersome for the provider and increasingly susceptible to human error.

Certain improvements have been directed toward automating such approaches using computer technology. For example, U.S. Pat. No. 8,380,542 to Wons et al. describes a centralized server that sends an assessment based on a patient record, receives a measurement result and prepares a care plan. However, such systems typically require continuous access to servers that securely hold patient information and set forth subsequent actions. Consequently, in remote environments in which network connectivity may be limited or nonexistent, the ability to provide effective healthcare services to patients using such technology is severely hampered. In addition, the ability to recognize and provide next step care in urgent situations may also be hindered.

What is needed is an improved mechanism for consistently and reliably providing effective healthcare services to patients in dynamic and remote environments without the drawbacks of voluminous materials, susceptibility to human errors and continuous network access.

### SUMMARY OF THE INVENTION

The inventors have recognized that precise synchronization of remote data coupled with local compression and verification technologies enables healthcare providers to employ a device with locally stored patient information and clinical pathways for providing improved healthcare services in dynamic and remote environments. Patient information may be mapped to code sets and reported to patients and/or exchanged with health care organizations accordingly. In addition, patient information may be aggregated with other patient information to provide further improved localized results. Accordingly, more efficient, consistent and reliable healthcare services may be provided to patients in dynamic and remote environments.

Specifically, one aspect of the present invention includes a portable clinical apparatus for guiding treatment of a patient. The portable clinical apparatus may comprise a local input/output (“I/O”) interface, a network I/O interface, a local database and an electronic processor executing a program stored in a non-transient medium. The electronic processor may execute to: (a) receive via the local I/O interface a login credential controlling a level of access of patient information stored in the local database; (b) validate the login credential, and upon successful validation of the login credential, access the patient information to retrieve a corresponding plan of care; (c) evaluate a first clinical pathway for treatment based on the plan of care and output to the local I/O interface a first treatment content based on the first clinical pathway; (d) receive via the local I/O interface a first treatment data provided in response to the first treatment content; and (e) evaluate a second clinical pathway for treatment based on the first treatment data received and output to the local I/O interface a second treatment content based on the second clinical pathway.

It is thus a feature of at least one embodiment of the invention to securely access patient information locally and guide a healthcare provider through an outcome based procedure for treating a patient in a mobile environment with limited or nonexistent access to a remote server or the Internet.

The portable clinical apparatus may further map the first treatment data to a medical code set stored in the local database, such as a code for International Classification of Diseases (“ICD”), a code for Systematized Nomenclature of Medicine (“SNOMED”) or a codes for Logical Observation Identifiers Names and Codes (“LOINC”).

It is thus a feature of at least one embodiment of the invention to locally and immediately transform the derived care information into a format suitable for industry standard consumption.

The portable clinical apparatus may further, after step (e), synchronize the local database to a server via the network I/O interface.

It is thus a feature of at least one embodiment of the invention to periodically synchronize to a remote server at precisely controlled times to maximize patient care while offline, in between synchronizations.

The portable clinical apparatus may further aggregate the first treatment data with a second treatment data from a different patient and modify a clinical pathway accordingly.

It is thus a feature of at least one embodiment of the invention to locally leverage useful information from other patients with similar circumstances to offer improved care locally to a patient.

Also disclosed are computer programs and software for implementing the above stated methods, and hardware elements for implementing the above stated methods.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout, and in which:

FIG. 1 is a block diagram of a portable clinical device for guiding treatment of a patient in accordance with an embodiment of the invention;

FIG. 2 is an exemplar graph illustrating a possible organization of patient oriented information stored in a local database of the portable clinical device of FIG. 1;

FIG. 3 is a process for guiding treatment of a patient in accordance with an embodiment of the invention;

FIG. 4 is a process for further guiding treatment of a patient in accordance with an embodiment of the invention;

FIG. 5 is a process illustrating an exemplar decision tree illustrating clinical pathways stored in a local database of a portable clinical device in accordance with an embodiment of the invention; and

FIG. 6 is an exemplar system for guiding treatment of patients comprising multiple clinical devices in accordance with an embodiment of the invention.

### DETAILED DESCRIPTION OF THE PREFERRED EMBODIMENTS

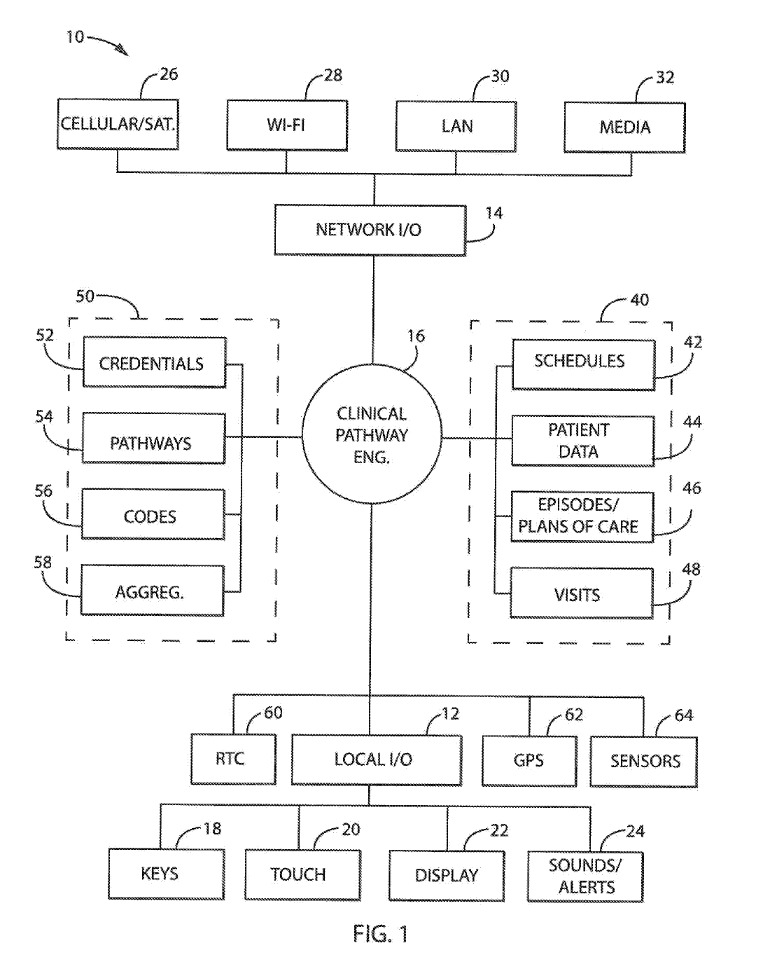

Referring now to FIG. 1, a portable clinical device 10 for guiding treatment of a patient in accordance with an embodiment of the invention is provided. The portable clinical device 10 comprises a local I/O interface 12, a network I/O interface 14 and a clinical pathway engine 16. The clinical pathway engine 16 may be an electronic processor executing a program stored in a non-transient medium, such as Flash memory, DRAM, SRAM or other media, or may be implemented in other hardware, firmware, or a combination thereof. In embodiments, the portable clinical device 10 may be a laptop, a tablet computer or a smart phone.

The clinical pathway engine 16 is in communication with the local I/O interface 12 and the network I/O interface 14. The local I/O interface 12, in turn, enables local input from and output to a user via keys 18, a touch screen 20, a graphical display 22, and/or sounds and alerts 24 via speakers and internal vibration producing mechanisms. The sounds and alerts 24 may be used, for example, to trigger alarms, emphasize alerts, or test patient hearing. In other embodiments, other conventional and/or proprietary mechanisms of local input from and output to a user may also be used, including printers, scanners, mice, portable media and standard or proprietary buses, including Lightning, Bluetooth and Infrared. Accordingly, the local I/O interface 12 permits the clinical pathway engine 16 to interact with a healthcare practitioner.

The network I/O interface 14, in turn, enables input from and output to a network, the Internet or Virtual Private Network (“VPN”) via a cellular and/or satellite communication system 26, a wireless local area network or “Wi-Fi” communication system 28, a wired local area network or “LAN” communication system 30, and/or other media interface 32, which may include portable media and standard or proprietary buses. In other embodiments, other conventional and/or proprietary mechanisms of input from and output to a network may also be used, including Lightning, Bluetooth and Infrared. Accordingly, the network I/O interface 14 permits the clinical pathway engine 16 to connect with a remote server during advantageous periods.

The clinical pathway engine 16 also is in communication with a local database storing patient oriented information 40 and clinical oriented information 50. For example, the local database may store such information in Flash memory, EEPROM or any other non-volatile rewritable media. One or more portions of the patient oriented information 40 and the clinical oriented information 50 may be compressed, and both the patient oriented information 40 and the clinical oriented information 50 and may be updated and/or modified when synchronized to a server at precisely controlled times.

The patient oriented information 40 may comprise, for example, patient schedules 42, patient specific data 44, patient episodes of care and/or plans of care 46, and/or patient visits 48. The patient schedule 42 sets forth the user's appointment schedule for visiting patients during a particular period of time, such as one or more days, weeks or months, which may correspond to a period of time between server synchronizations. The patient specific data 44 sets forth more detailed information about each patient in the patient schedule 42, such as the patient's address, telephone or email information, emergency contact, insurance details, date of birth, height, weight, blood type, medications and/or other basic information. The patient episodes of care and/or plans of care 46 sets forth the comprehensive listings of conditions and plans for which patients are being treated. The patient visits 48 sets forth the details and outcomes of each interaction a healthcare practitioner or other user has with the patient.

The clinical oriented information 50 may comprise, for example, login credentials 52, clinical pathways 54, medical code sets 56 and/or aggregated data 58. The login credentials 52 sets forth user names, passwords, personal identification numbers (“PIN”), private cryptographic keys, common access cards and/or a biometric scanners. Successful verification of the login credentials 52 permits the user a level of access to the patient oriented information 40 and/or the clinical oriented information 50. Different types of login credentials may also be provided for different types of users, and the level of access granted with respect to each patient may vary. Accordingly, multiple users could use the portable clinical device 10 at different times with varying levels of access to the patient information in between synchronizations to the server.

The clinical pathways 54 sets forth a set of logic or rules which enables delivery of outcome based care. The clinical pathways 54 may also provide step by step procedures or a task list for caring for a patient during a visit based on previous information known about the patient and newly provided information during the visit. The clinical pathways 54 guides which content to present, such as interventions, goals, tasks, reminders, priorities, assessments, summary information, physician orders, notifications and/or clinical alerts, and which next content should be presented based on treatment data entered by the user. The clinical pathways 54 may also map discrete content to patient education tools which may also be presented, such as book images, photos, videos, sounds, text or other informative media. Such content and tools may be provided in a base language, such as English or Spanish, and an embedded language translation service may be utilized to provide dynamic translations into other languages.

The medical code sets 56 sets forth a table or other data structure for mapping patient oriented treatment content and/or treatment data to a medical code set or terminology for subsequent sharing. Accordingly, the clinical pathway engine 16 could use the medical code sets 56 to map patient oriented treatment content and/or treatment data to codes for International Classification of Diseases (“ICD”), such as ICD-9, or codes for Systematized Nomenclature of Medicine (“SNOMED”), or codes for Logical Observation Identifiers Names and Codes (“LOINC”), and so forth. Such mapping facilitates subsequent transmission and sharing of the patient oriented treatment content and/or treatment data to Accountable Care Organizations (“ACO's”), doctors, hospitals, insurance companies, government agencies and other proper parties.

The aggregated data 58 sets forth information about other patients for establishing correlations between outcomes of patients. For example, the aggregated data 58 may permit an analysis of information about other patients to determine whether a certain treatment could improve a certain condition for a particular patient. Accordingly, the clinical pathway engine 16 could use the aggregated data 58 to locally derive a plan of care or treatment content that is more likely to lead to a successful outcome for a patient. Other patient information, such as other patient's dates of birth, height, weight, blood types and/or medications, could also be considered in the aggregated data 58 and in the analysis by the clinical pathway engine 16.

The clinical device 10 may also comprise a real time clock (“RTC”) 60, a Global Positioning System (“GPS”) interface 62 and other system sensors 64. The RTC 60 provides an accurate time stamp, and the GPS interface 62 provides an accurate location, each of which may be recorded for significant occurring events, such as synchronizations to the server, delivery of treatment content, reception of treatment data, generations of reports and transmission or sharing of patient information. The sensors 64 may include cameras, accelerometers, gyroscopes or any other sensors as known in the art and which may provide beneficial tools in patient care settings.

In practice, the patient oriented information 40 and the clinical oriented information 50 may be synchronized with a server periodically and at advantageous times while not being hindered by loss of a network connection in between. For example, a user may synchronize with a server while in an area with a reliable Internet connection, and then proceed to the field for an extended period of time to provide maximal care for patients. The user may then return to the area with a reliable Internet connection to synchronize with the server again and to provide updates with respect to the care provided in the field. The user may also synchronize with the server for the purpose of modifying the patient oriented information 40 and the clinical oriented information 50 from updates in the server and for proceeding back into the field again. Accordingly, precise control of the synchronization of data, coupled with effective compression of the patient oriented information 40 and the clinical oriented information 50, and verification via login credentials, enables the user to use the portable clinical device 10 for providing healthcare services in dynamic and remote environments to maximum effect.

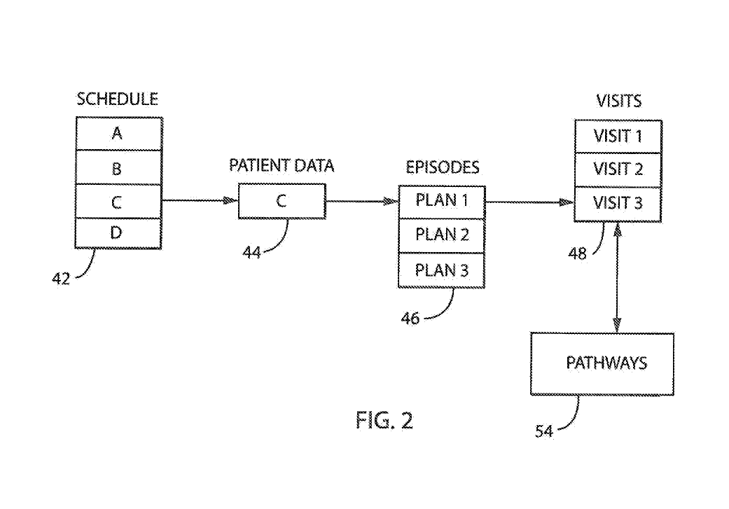

Referring now to FIG. 2, an exemplar graph illustrates a possible organization of patient oriented information 40 stored in the local database of the portable clinical device 10 of FIG. 1. Upon successful validation of the login credentials 52, the user may access the patient schedule 42 within the user's permissions, which may set forth, for example, an appointment schedule for visiting patients “A,” “B,” “C” and “D” during a period of time between server synchronizations. The user may select patient C, which may then produce the patient specific data 44 with respect to patient C. The user may then access episodes of care and/or plans of care 46 for patient C, which may include patient C's “Plan 1,” “Plan 2” and “Plan 3.” For example, Plan 1 may be a treatment plan of care for diabetes, Plan 2 may be a treatment plan of care for asthma, and Plan 3 may be a treatment plan of care for an elbow injury. Accordingly, the user may select a particular episode of care and/or plan of care, such as Plan 1, or create a new episode of care and/or plan of care locally.

Next, the user may access the patient visits 48 corresponding with the selected episodes of care and/or plans of care 46. The user may then select a visit for viewing, such as “Visit 1” or “Visit 2,” or create a new visit, such as “Visit 3.” The clinical pathway engine 16, using the clinical pathways 54 stored in the clinical oriented information 50, may then evaluate a clinical pathway for continuing the treatment based on Plan 1 (and considering Plans 2 and 3), and output to the local I/O interface, such as via the display 22, treatment content based on the evaluated clinical pathway (e.g., “What's the patient's temperature?”). The clinical pathway engine 16 may then receive via the local I/O interface, such as via the touch screen 20, treatment data provided in response to the treatment content (e.g., “100.0° F.”). The clinical pathway engine 16 may then evaluate the next clinical pathway for treatment based on the treatment data that was received and output to the local I/O interface the next treatment content based on the next clinical pathway (e.g., “Has the patient taken fever reducing medication?”).

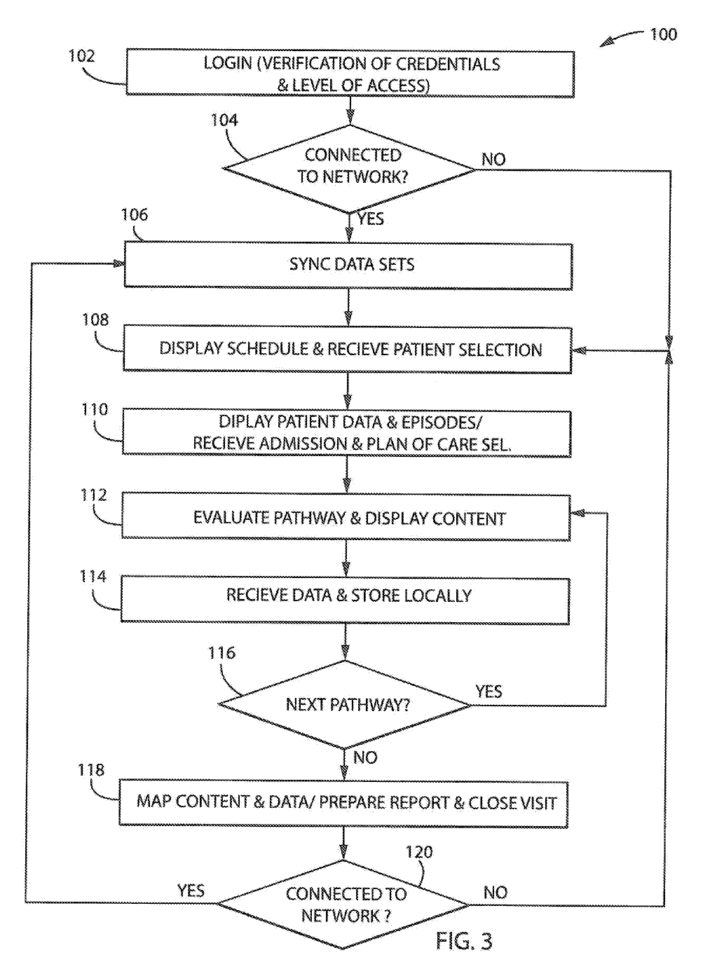

Referring now to FIG. 3, a process 100 for guiding treatment of a patient is provided in accordance with an embodiment of the invention. In process block 102, login credentials are provided by a user and validated to permit the user a level of access to patient information. Logging in may occur while connected to a remote server via a network 1/O interface, or may occur while “off line” from the server without the benefit of any network I/O connection. The login credentials may also be single sign-on (“SSO”) credentials, enabling the user to log in once and gain continuing access without being prompted to log in again for each interaction. Successful validation of the login credential may be required before continuing further.

Next, in decision block 104, it is determined whether there is a connection to a network for connection to a server. If there is in fact a connection, in process block 106, local data sets, such as such as patient information, patient reports, clinical pathways, medical code sets, and so forth, may be synchronized with the server, thereby updating both local system records and the server's records. However, if a reliable connection cannot be established, process block 106 is bypassed.

Next, in process block 108, which may begin offline, patient information is locally accessed and graphically displayed to the user. The patient information displayed may conveniently be provided as a schedule of appointments that lists various patients. However, alternative embodiments may simply provide a directory of patients from which one or more may be selected, or other such content delivery as known in the art. Accordingly, a patient selection is received.

Next, in process block 110, the selected patient may be “admitted” for the visit, at which point information about the selected patient may be displayed. In addition to such information, which may include, for example, the patient's address, telephone or email information, emergency contact, insurance details, date of birth, height, weight, blood type, medications and/or other basic information, information about the patient's episodes of care and/or plans of care may be displayed. Accordingly, an episode of care and/or plan of care may be selected, along with recommendations for care.

Next, in process block 112, a clinical pathway for treatment based on the plan of care is evaluated. A treatment content based on the clinical pathway is then displayed to the user. The treatment content may include, for example, interventions, goals, tasks, reminders, priorities, assessments, summary information, physician orders, notifications, clinical alerts, questions and so forth.

Next, in process block 114, a treatment data is received in response to the treatment content. The treatment data may include, for example, answers, assessments, actions taken, statuses (e.g., “met,” “not met,” “done,” “not done,” “no show”), explanations, comments, notes, measurements and so forth. The treatment content and the treatment data are stored locally, along with a timestamp and/or GPS location.

Next, in decision block 116, logic and rules are immediately run locally to determine whether there is a next clinical pathway in view of the treatment data (and in view of any other pertinent patient information). This may be determined, for example, as part of delivering the outcome based care. If a next clinical pathway is in fact determined, the process 100 returns to process block 112, in which case a next clinical pathway is evaluated and a next treatment content is displayed, then to process block 114, in which case a next treatment data is provided. However, if there is not a next clinical pathway, then process 100 instead continues to process block 118.

Next, in process block 118, the treatment content and/or data is mapped using a stored medical code sets or terminology, such as ICD-9, SNOMED or LOINC. Accordingly, the treatment content and/or data are locally and immediately transformed into a format suitable for industry standard consumption. In addition, a report of the treatment content and/or data is prepared, and the patient visit is closed.

Next, in decision block 120, it is determined again whether there is a connection to a network for connection to a server. If there is in fact a connection, the process 100 returns to process block 106 for synchronization of the local data sets, such as patient information, reports, clinical pathways, medical code sets, and so forth, thereby updating both local system records and the server records. However, if there is not a connection, the process 100 returns to process block 108 to start again for the same patient or a next patient.

Embodiments may further provide a “manual” synchronization step, such as a “sync button,” which may be inserted at any desired step in the process 100 to force a synchronization attempt at that point. Embodiments may also provide an “automatic” synchronization step, which may be based on particular events or times, such as a number patients seen, a time of day, or a period of time elapsed, upon which a synchronization is automatically attempted. Unsuccessful synchronization attempts may further be logged and queued for subsequent synchronization reattempts at events or times which may be configurable.

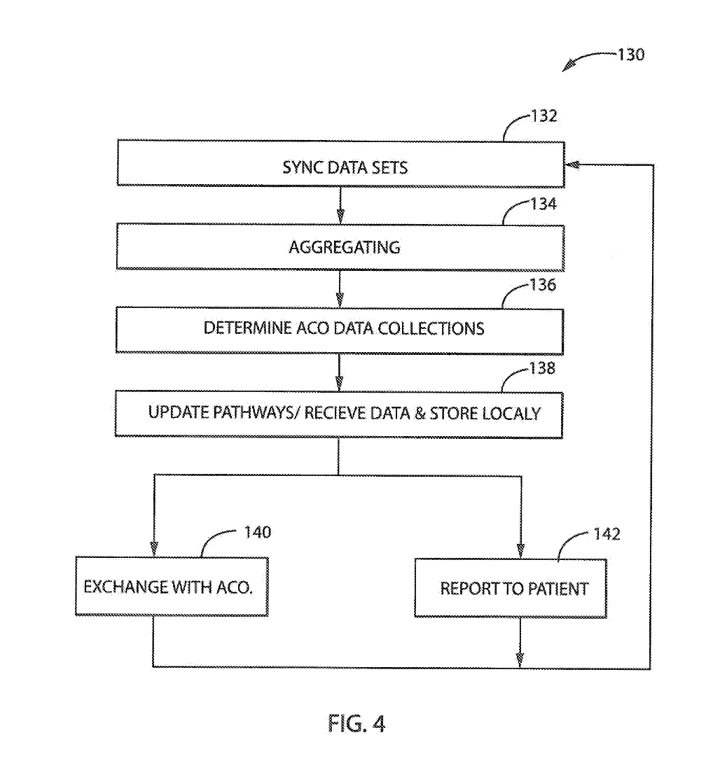

Referring now to FIG. 4, a process 130 for further guiding treatment of a patient is provided in accordance with an embodiment of the invention. In process block 132, local data sets, such as such as patient information, patient reports, clinical pathways, medical code sets, and so forth, are synchronized with the server, thereby updating both local system records and the servers records.

In addition, aggregated data setting forth information about other patients is also synchronized with the server. The aggregated data may include other patient's plans of care and information such as date of birth, height, weight, blood type and/or medications. By way of example, the effectiveness of a particular therapy for a condition in treating other patients may be locally leveraged for the benefit of a particular patient, while the particular patient's response may be similarly aggregated with other patients.

In addition, specialized information from ACO's, doctors, hospitals, insurance companies, government agencies or other proper parties is also synchronized with the server. The specialized information may include information desirable to include for particular patients from the particular organizations. By way of example, an ACO may choose to begin capturing a specific data point for all patients having a particular condition, or may suggest a particular course of action for all patients having some other condition. Accordingly, those desires may be synchronized in process block 132 for subsequent action.

Next, in process block 134, which may begin offline, and during the course of treatment for a patient, the aggregated data is locally analyzed to determine whether a certain treatment could improve a certain condition for a particular patient. Similarly, in process block 136, the specialized information is locally analyzed to determine applicability for a particular patient.

Next, in process block 138, one or more clinical pathways are updated and/or modified based on the aggregated data and/or the specialized information. Accordingly, with such further guiding enabled, when evaluating a clinical pathway, the aggregated data and/or the specialized information may also be considered in coordination with presenting treatment content based on a clinical pathway.

Next, in process block 140, an electronic report may be generated including treatment content and/or treatment data and exchanged with the ACO or other proper party. In addition, or in the alternative, in process block 142, an electronic report may be generated including treatment content and/or treatment data, and the electronic report may be electronically transmitted to the patient or other proper party.

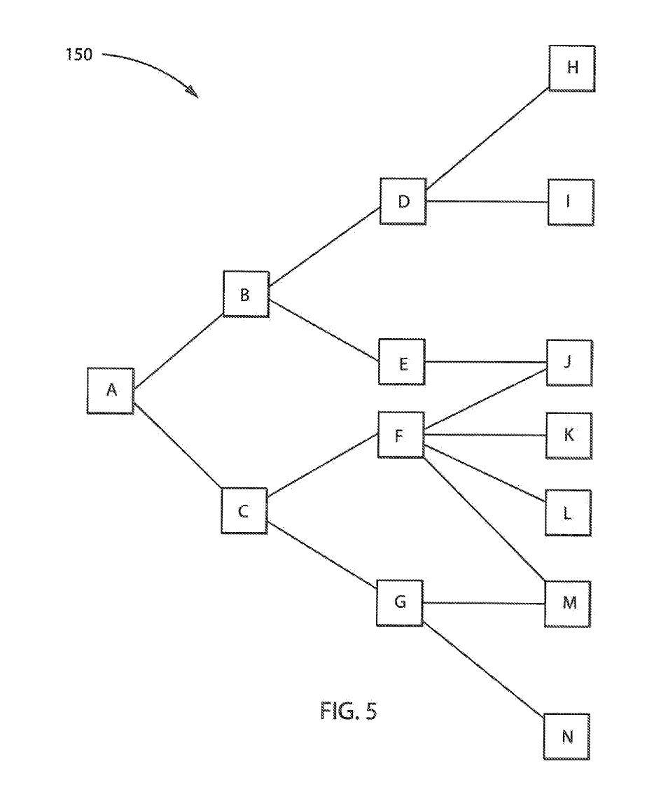

Referring now to FIG. 5, an exemplar decision tree 150 illustrating clinical pathways stored in a local database of a portable clinical device is provided in accordance with an embodiment of the invention. Based on the selection of patient information, patient specific data, patient episodes of care and/or plans of care, and/or patient visits, initial treatment content “A” is presented or displayed. Based on treatment data that is received, a next clinical pathway is evaluated, which leads to a next treatment content “B” or “C” being presented or displayed. Assuming, for example, the next treatment content is “B,” based on a next treatment data that is received, yet another clinical pathway is evaluated, which leads to a yet another treatment content, such “D” or “E,” being presented or displayed. This process continues until a final treatment content is reached, such as treatment content “H,” “I,” “J,” K,” “L,” “M” or “N.”

It should be noted that evaluation of different clinical pathways may lead to the same treatment content, such as different clinical pathways may lead to the same treatment content “J,” or the same treatment content “M.” However, more typically, different clinical pathways will lead to different treatment content.

Embodiments may also employ an “auto-population” mechanism. Accordingly, upon receiving particular treatment data, some clinical pathways may be evaluated more quickly by skipping past all or parts of a particular treatment content by auto-populating certain results. Alternative embodiments may also provide other techniques for implementing clinical pathways, including, for example, task lists.

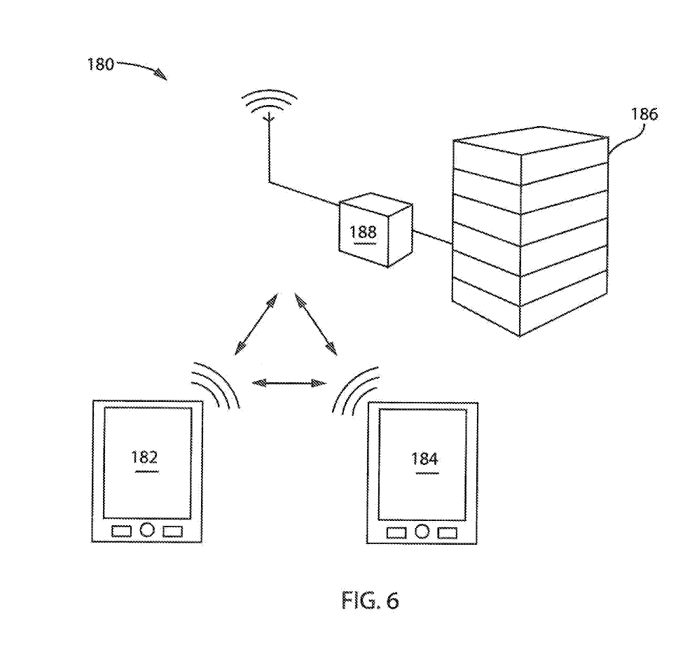

Referring now to FIG. 6, an exemplar system 180 for guiding treatment of patients comprising multiple clinical devices is provided in accordance with an embodiment of the invention. A first portable clinical device 182 in the system 180 may be a tablet computer including a local I/O interface, a network I/O interface, a local database and an electronic processor executing a program stored in a non-transient medium. A second portable clinical device 184 in the system 180 may be another tablet computer including a local I/O interface, a network I/O interface, a local database and an electronic processor executing a program stored in a non-transient medium. Accordingly, two or more healthcare providers may be working together treating patients in the field.

The first and second portable clinical devices 182 and 184 may each operate according to one or more of the embodiments described above with respect to FIGS. 1-5. In addition, the first and second portable clinical devices 182 and 184 may each operate independently of one another, or may communicate and share information with one another. If communicating with one another, for example, the first and second portable clinical devices 182 and 184 may communicate with one another via their network I/O interfaces, such as via Wi-Fi, Bluetooth, Infrared or other technology, to exchange treatment content, treatment data, aggregated data, specialized data, clinical pathways and/or any other data sets as desired and as login credentials may permit.

The first and second portable clinical devices 182 and 184 may each also communicate wirelessly, such as via cellular and/or satellite communications systems, to a server 186 in the system 180. The server 186, in turn, may be coupled to the cellular and/or satellite communications systems via a networking system 188. Accordingly, more efficient, consistent and reliable healthcare services may be provided using such portable clinical devices in dynamic and remote environments without excessive reliance on distant resources such as servers, including with devices working in tandem.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

It should be appreciated that such a development effort might be complex and time consuming, but would nevertheless be a routine undertaking of design, fabrication, and manufacture for those of ordinary skill having the benefit of this disclosure. Nothing in this application is considered critical or essential to the present invention unless explicitly indicated as being “critical” or “essential.”

What is claimed is:

1. A portable clinical apparatus for guiding treatment of a patient, the clinical apparatus comprising a local I/O interface, a network I/O interface, a local database and an electronic processor executing a program stored in a non-transient medium to:
(a) receive via the local I/O interface a login credential controlling a level of access of patient information stored in the local database;
(b) validate the login credential, and upon successful validation of the login credential, access the patient information to retrieve a corresponding plan of care;
(c) evaluate a first clinical pathway for treatment based on the plan of care and output to the local I/O interface a first treatment content based on the first clinical pathway;
(d) receive via the local I/O interface a first treatment data provided in response to the first treatment content; and
(e) evaluate a second clinical pathway for treatment based on the first treatment data received and output to the local I/O interface a second treatment content based on the second clinical pathway.

2. The portable clinical apparatus of claim 1, further comprising to map the first treatment data to a medical code set stored in the local database.

3. The portable clinical apparatus of claim 2, wherein the medical code set corresponds to at least one of a code for International Classification of Diseases (ICD) and a code for Systematized Nomenclature of Medicine (SNOMED).

4. The portable clinical apparatus of claim 1, further comprising, after step (e), to synchronize the local database to a server via the network I/O interface.

5. The portable clinical apparatus of claim 4, wherein the network I/O interface comprises at least one of cellular communication and wireless local area network communication.

6. The portable clinical apparatus of claim 1, further comprising, after step (e), to queue a synchronization attempt of the local database to a server via the network I/O interface for synchronization later in time.

7. The portable clinical apparatus of claim 1, wherein the local I/O interface comprises a graphical display with a touch screen.

8. The portable clinical apparatus of claim 7, wherein the apparatus is a tablet computer.

9. The portable clinical apparatus of claim 1, wherein evaluation of the first and second clinical pathways are based on a decision tree stored in the local database.

10. The portable clinical apparatus of claim 1, further comprising to aggregate the first treatment data with a second treatment data from a different patient and to modify a clinical pathway accordingly.

11. The portable clinical apparatus of claim 1, further comprising to generate an electronic report including the first treatment data and to transmit the electronic report via the network I/O interface.

12. A method for guiding treatment of a patient using a portable clinical device having a local I/O interface, a network I/O interface and a local database, the method comprising:
(a) receiving via the local I/O interface a login credential controlling a level of access of patient information stored in the local database;
(b) validating the login credential, and upon successful validation of the login credential, accessing the patient information to retrieve a corresponding plan of care;
(c) evaluating a first clinical pathway for treatment based on the plan of care and outputting to the local I/O interface a first treatment content based on the first clinical pathway;
(d) receiving via the local I/O interface a first treatment data provided in response to the first treatment content; and
(e) evaluating a second clinical pathway for treatment based on the first treatment data received and outputting to the local VO interface a second treatment content based on the second clinical pathway.

13. The method of claim 12, further comprising mapping the first treatment data to a medical code set stored in the local database.

14. The method of claim 12, further comprising, after step (e), synchronizing the local database to a server via the network I/O interface.

15. The method of claim 12, further comprising, after step (e), queuing a synchronization attempt of the local database to a server via the network 1/O interface for synchronization later in time.

16. The method of claim 12, further comprising aggregating the first treatment data with a second treatment data from a different patient and modifying a clinical pathway accordingly.

17. The method of claim 12, further comprising generating an electronic report including the first treatment data and transmitting the electronic report via the network I/O interface.

18. A system for guiding treatment of patients comprising:
a first clinical device having a local I/O interface, a network I/O interface, a local database and an electronic processor executing a program stored in a non-transient medium; and
a second clinical device having a local I/O interface, a network I/O interface, a local database and an electronic processor executing a program stored in a non-transient medium;
wherein the first and second clinical devices each:
(a) receive via their local I/O interface a login credential controlling a level of access of patient information stored in their local database;
(b) validate the login credential, and upon successful validation of the login credential, access the patient information to retrieve a corresponding plan of care;
(c) evaluate a first clinical pathway for treatment based on the plan of care and output to their local I/O interface first treatment content based on the first clinical pathway;
(d) receive via their local I/O interface a first treatment data provided in response to the first treatment content; and
(e) evaluate a second clinical pathway for treatment based on the first treatment data received and output to their local I/O interface a second treatment content based on the second clinical pathway; and
wherein the first and second clinical devices communicate with one another via their network I/O interfaces to exchange first and second treatment data.

19. The system of claim 18, wherein the first and second clinical devices each aggregate the first and second treatment data from the other device and modify a clinical pathway accordingly.

20. The system of claim 18, wherein the first and second clinical devices each map first treatment data to a medical code set stored in their local database.
